(19) United States
(12) Patent Application Publication
(10) Pub. No.: US 2011/0301932 A1
(43) Pub. Date: Dec. 8, 2011

(54) MOSFET MODEL OUTPUT APPARATUS AND METHOD, AND RECORDING MEDIUM

(75) Inventors: Sadayuki YOSHITOMI, Tokyo (JP); Naoki WAKITA, Kawasaki-Shi (JP); Yuka ITANO, Kawasaki-Shi (JP); Fumie FUJII, Yokohama-Shi (JP)

(73) Assignee: KABUSHIKI KAISHA TOSHIBA, Tokyo (JP)

(21) Appl. No.: 13/041,206

(22) Filed: Mar. 4, 2011

(30) Foreign Application Priority Data
Jun. 2, 2010 (JP) 2010-126900

(51) Int. Cl. G06F 17/50

(52) U.S. Cl. 703/14

(57) ABSTRACT

In one embodiment, a MOSFET model output apparatus is configured to output a MOSFET model for a simulation of a semiconductor circuit. The apparatus includes a shape data input part configured to input shape data of a MOSFET. The apparatus further includes a parameter calculation part configured to calculate a parameter of a parasitic device model to be added to the MOSFET model, using the shape data. The apparatus further includes a MOSFET model output part configured to generate and output the MOSFET model added with the parasitic device model, using the parameter of the parasitic device model. Further, the MOSFET model output part adds different parasitic device models to the MOSFET model in a case where the MOSFET is an N-type MOSFET and in a case where the MOSFET is a P-type MOSFET.

### CROSS REFERENCE TO RELATED APPLICATION

This application is based upon and claims the benefit of priority from the prior Japanese Patent Application No. 2010-126900, filed on Jun. 2, 2010, the entire contents of which are incorporated herein by reference.

### FIELD

Embodiments described herein relate to a MOSFET model output apparatus and method, and recording medium, for example, to a MOSFET model to be used in a SPICE (Simulation Program with Integrated Circuit Emphasis) circuit simulation, such as a SPICE model of a MOSFET used in an analog circuit or an RF circuit.

### BACKGROUND

An example of a MOSFET model for a SPICE circuit simulation is a four-terminal model. In circuit designing of a semiconductor integrated circuit, the SPICE circuit simulation considering a parasitic device is often performed using the four-terminal model or the like.

However, the four-terminal model has such a problem that the high frequency characteristic effect of bias application to a deep N-type well cannot be estimated. Further, since a substrate and a well are not connected on a net list, there is a problem that cross-talk noise analysis through the substrate cannot be performed. The cross-talk noise analysis is very important in circuit designing particular on future mixed signal integrated circuit development. The four-terminal model has a further problem that a connection verification of the deep N-type well cannot be performed in connection verifications after layout designing.

In this technical field, there are various known methods of generating a model for the SPICE circuit simulation considering the parasitic device. However, those methods have a problem that it is difficult to suitably incorporate the effect of the parasitic device into the model.

### BRIEF DESCRIPTION OF THE DRAWINGS

FIG. 1 is a block diagram showing a configuration of a MOSFET model output apparatus of an embodiment of the disclosure;

FIG. 2 is a circuit diagram showing examples of MOSFET models outputted from the apparatus of FIG. 1;

FIG. 3 is a plan view showing structures of MOSFETs handled in the present embodiment;

FIG. 4 is a table showing definitions of variables shown in FIG. 3; and

FIG. 5 is a sectional side view showing cross sections of an N-type MOSFET and a P-type MOSFET.

### DETAILED DESCRIPTION

Embodiments will now be explained with reference to the accompanying drawings.

An embodiment described herein is, for example, a MOSFET model output apparatus configured to output a MOSFET model for a simulation of a semiconductor circuit. The apparatus includes a shape data input part configured to input shape data of a MOSFET. The apparatus further includes a parameter calculation part configured to calculate a parameter of a parasitic device model to be added to the MOSFET model, using the shape data. The apparatus further includes a MOSFET model output part configured to generate and output the MOSFET model added with the parasitic device model, using the parameter of the parasitic device model. Further, the MOSFET model output part adds different parasitic device models to the MOSFET model in a case where the MOSFET is an N-type MOSFET and in a case where the MOSFET is a P-type MOSFET.

Another embodiment described herein is, for example, a MOSFET model output method of outputting a MOSFET model for a simulation of a semiconductor circuit. The method includes inputting shape data of a MOSFET into an information processing apparatus. The method further includes calculating a parameter of a parasitic device model to be added to the MOSFET model by the apparatus using the shape data. The method further includes generating and outputting the MOSFET model added with the parasitic device model by the apparatus using the parameter of the parasitic device model. Further, different parasitic device models are added to the MOSFET model in a case where the MOSFET is an N-type MOSFET and in a case where the MOSFET is a P-type MOSFET.

Another embodiment described herein is, for example, a computer readable recording medium storing a program to cause a computer to execute a MOSFET model output method of outputting a MOSFET model for a simulation of a semiconductor circuit. The method includes calculating a parameter of a parasitic device model to be added to the MOSFET model, using shape data of a MOSFET inputted into the computer. The method further includes generating and outputting the MOSFET model added with the parasitic device model, using the parameter of the parasitic device model. Further, different parasitic device models are added to the MOSFET model in a case where the MOSFET is an N-type MOSFET and in a case where the MOSFET is a P-type MOSFET.

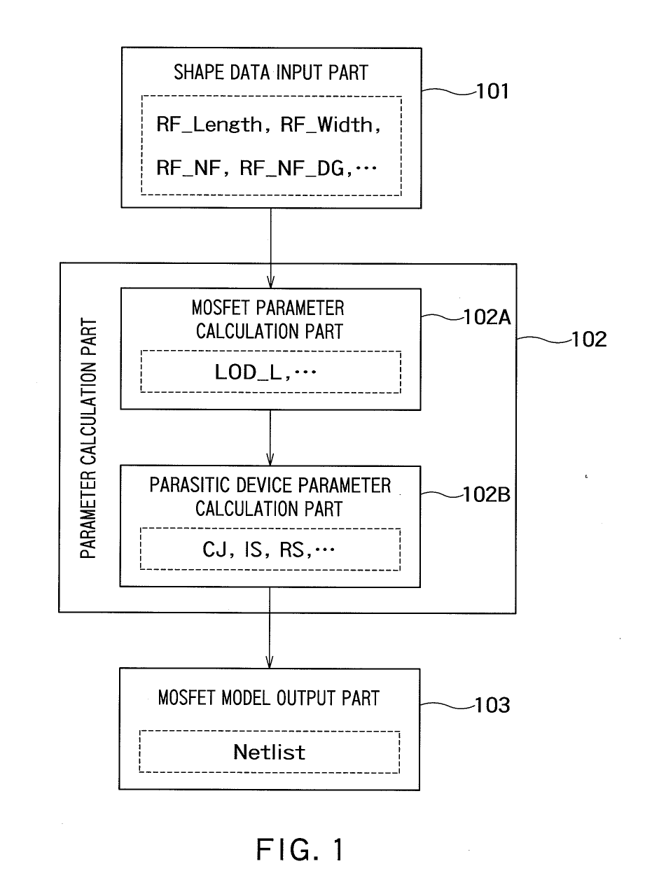

FIG. 1 is a block diagram showing a configuration of a MOSFET model output apparatus of an embodiment of the disclosure. The apparatus of FIG. 1 is configured to output a MOSFET model for a simulation of a semiconductor circuit.

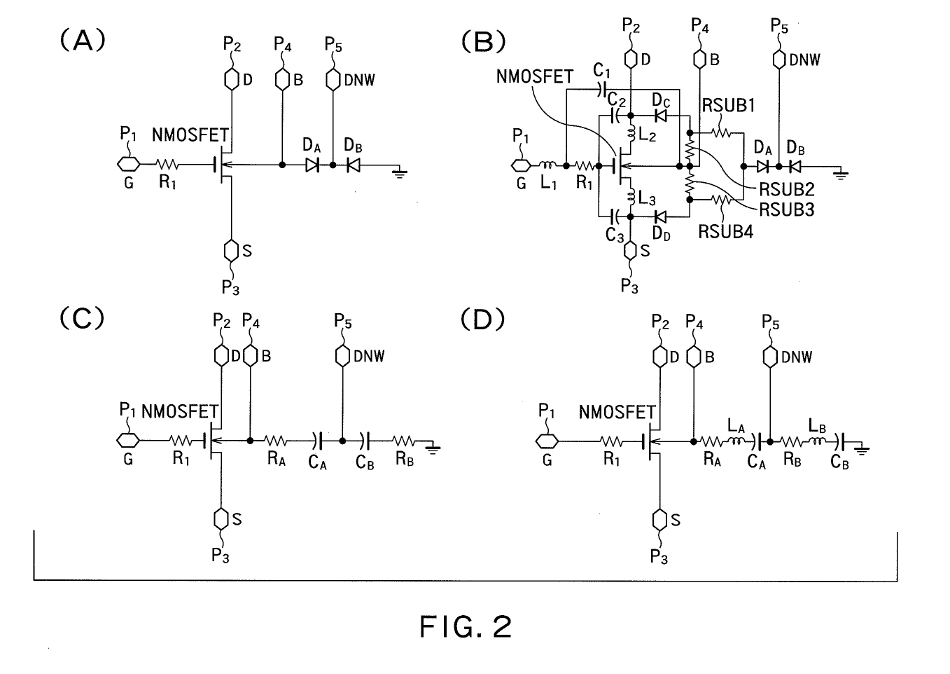

The apparatus of FIG. 1 includes a shape data input part 101, a parameter calculation part 102, and a MOSFET model output part 103, as blocks for such processing. In addition, the parameter calculation part 102 includes a MOSFET parameter calculation part 102A, and a parasitic device parameter calculation part 102B. Details of those blocks will be described with reference to FIGS. 2 to 5.

FIG. 2 is a circuit diagram showing examples of MOSFET models outputted from the apparatus of FIG. 1.

In each of the examples shown in FIGS. 2(A) to 2(D), it is assumed a MOSFET model where a deep N-type well is formed on a surface of a P-type substrate, a P-type well is then formed on a surface of the deep N-type well, and a MOSFET (N-type MOSFET) is further formed on the P-type well.

In addition, FIGS. 2(A) to 2(D) show five terminals P₁ to P₅. Therefore, the MOSFET models shown in FIGS. 2(A) to 2(D) are five-terminal models. In each MOSFET model, the terminals P₁, P₂, and P₃ are connected respectively to a gate, a drain, and a source of the MOSFET. The terminal P₄ is connected to the P-type well. The terminal P₅ is connected to the deep N-type well. The terminal P₄ is connected to a base of the MOSFET. Each of FIGS. 2(A) to 2(D) further shows a ground line connected to the P-type substrate.

In the present embodiment, as shown in FIGS. 2(A) to 2(D), a MOSFET model added with a parasitic device model which is a model of a parasitic device is generated and outputted.

Each of FIGS. 2(A) and 2(B) shows, as parasitic devices, a junction diode D_{A} between the P-type well and the deep N-type well, and a junction diode D_{B} between the deep N-type well and the P-type substrate. The junction diodes D_{A} and D_{B} face the opposite directions, and cathodes of the junction diodes D_{A} and D_{B} are located on the deep N-type well side.

On the other hand, in each of FIGS. 2(C) and 2(D), the junction diodes D_{A} and D_{B} are replaced with their equivalent circuits. Specifically, in FIG. 2(C), the junction diode D_{A} is replaced with a series connection of a resistance R_{A} and a capacitor C_{A}, and the junction diode D_{B} is replaced with a series connection of a resistance R_{B} and a capacitor C_{B}. Similarly, in FIG. 2(D), the junction diode D_{A} is replaced with a series connection of the resistance R_{A}, an inductor L_{A}, and the capacitor C_{A}, and the junction diode D_{B} is replaced with a series connection of the resistance R_{B}, an inductor L_{B}, and the capacitor C_{B}.

The operations of the junction diodes D_{A} and D_{B} of FIGS. 2(A) and 2(B) are physically substantially similar to the operations of the equivalent circuits of FIGS. 2(C) and 2(D). The models of FIGS. 2(C) and 2(D) are applied when junction capacities of those diodes have a week inter-junction bias dependence, for example.

Details of the circuit diagrams of FIGS. 2(A) to 2(D) will be further described.

FIG. 2(A) shows a resistance R₁ provided between the gate of the MOSFET and the terminal P₁, as well as the junction diodes D_{A} and D_{B}. The same holds for FIGS. 2(C) and 2(D).

FIG. 2(B) shows the resistance R₁, inductors L₁, L₂, and L₃ respectively provided between the gate, drain, and source of the MOSFET and the terminals P₁, P₂, and P₃, capacitors C₁, C₂, and C₃ respectively provided between the terminal P₁ and the terminals P₄, P₂, and P₃, junction diodes D_{C} and D_{D} respectively derived from a drain diffusion layer and a source diffusion layer, and four-terminal substrate resistances RSUB1 to RSUB4, as well as the junction diodes D_{A} and D_{B}.

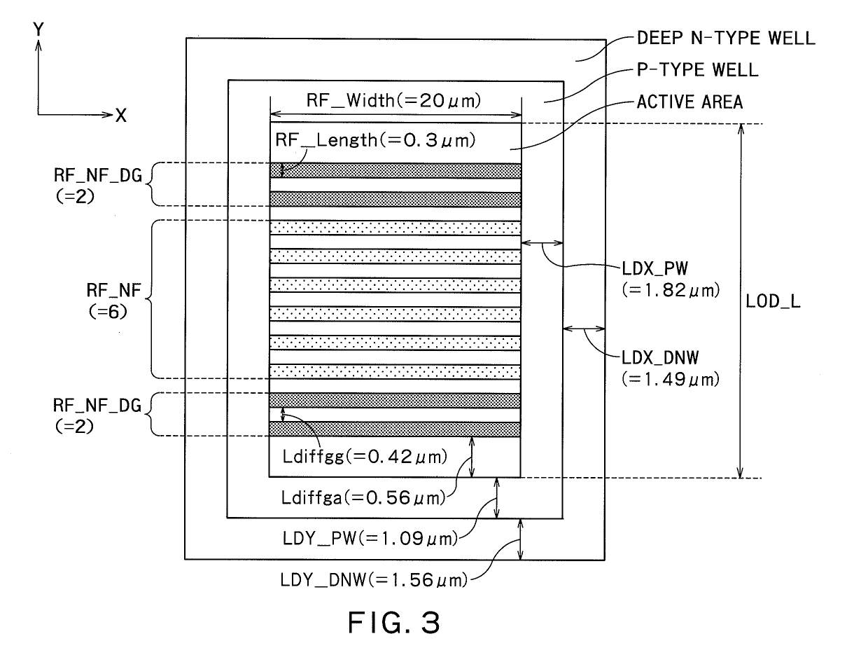

FIG. 3 is a plan view showing structures of MOSFETs handled in the present embodiment.

FIG. 3 shows multi-finger type MOSFETs. FIG. 3 further shows X and Y directions parallel to a principal plane of the substrate and perpendicular to each other. The X direction corresponds to the extending direction of the finger structures, and the Y direction corresponds to the repeating direction of the finger structures.

In the present embodiment, shape data which is data associated with a shape of a MOSFET is inputted to the shape data input part 101 (FIG. 1). FIG. 3 shows specific examples of the shape data.

FIG. 3 shows a gate length RF_Length, a gate width RF_Width, gate finger number RF_NF, and dummy gate finger number RF_NF_DG of the MOSFETs. Furthermore, FIG. 3 shows a distance Ldiffgg between the gates of the MOSFETs, and a distance Ldiffga between a dummy gate edge and an active area edge of the MOSFETs. In this case, the dummy gate edge is an edge of a dummy gate located on the outermost side in the Y direction, i.e., the edge of the dummy gate extending mostly outward on the STI (Shallow Trench Isolation) side.

FIG. 3 also shows distances LDX-PW and LDY-PW between the active area edge and the boundary between the P-type well and the deep N-type well. LDX-PW is the distance in the X direction (east-west direction), and LDY-PW is the distance in the Y direction (north-south direction). The X and Y directions are examples of the first and second directions of the disclosure, respectively.

FIG. 3 also shows distances LDX-DNW and LDY-DNW between the boundary between the P-type well and the deep N-type well and the boundary between the deep N-type well and the P-type substrate. LDX-DNW is the distance in the X direction (east-west direction), and LDY-DNW is the distance in the Y direction (north-south direction).

In FIG. 3, values in brackets following those variables are specific examples of the values of the variables.

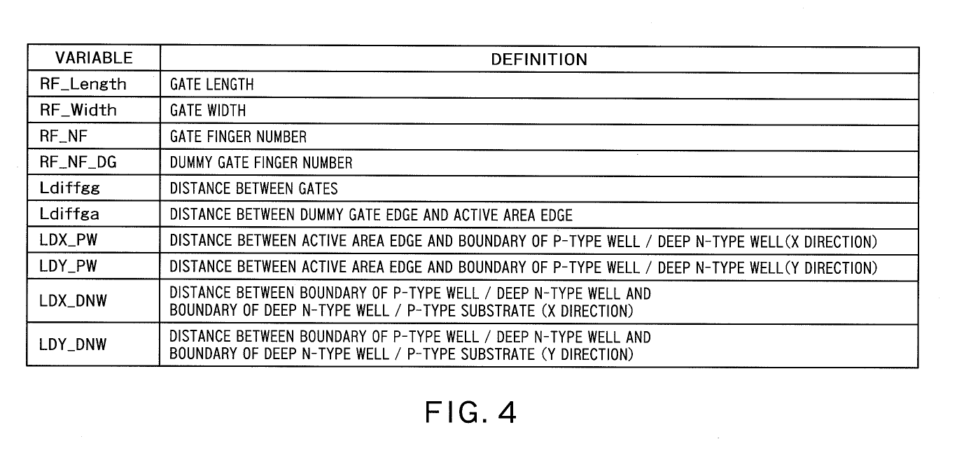

In FIG. 4, those ten variables are shown in a table. FIG. 4 is the table showing definitions of the variables shown in FIG. 3.

In the present embodiment, the values of those variables (i.e., shape data) are inputted to the shape data input part 101 of FIG. 1. Then, the parameter calculation part 102 calculates parameters of the parasitic device model to be added to the MOSFET model, using the inputted shape data. Subsequently, the MOSFET model output part 103 generates and outputs the MOSFET model added with the parasitic device model, using the calculated parameters.

FIGS. 2(A) to 2(D) show the examples of such MOSFET model. Each MOSFET model shown in FIGS. 2(A) to 2(D) is a macro model represented by one or more circuit devices. The MOSFET model output part 103 generates a net list of the MOSFET model and outputs the net list.

The shape data may be inputted to the shape data input part 101 by a user, or may be inputted to the shape data input part 101 from various recording media or other apparatuses.

In the present embodiment, the parameter calculation part 102 calculates the parameters of the parasitic device model, using the values of the all variables shown in FIG. 4, as described later. However, the parameters of the parasitic device model may be calculated using only the values of some of the variables shown in FIG. 4

Hereinafter, the processing performed by the MOSFET parameter calculation part 102A and the parasitic device parameter calculation part 102B shown in FIG. 1 will be described.

The MOSFET parameter calculation part 102A calculates the parameters of the MOSFET model, using the shape data.

Examples of the parameters of the MOSFET model include a length LOD_L, an area AA_AREA, and a peripheral length AA_PERI of the active area. LOD_L is the length in the Y direction of the active area, as shown in FIG. 3. In the following expressions (1) to (3), those parameters are represented by the variables shown in FIG. 3.

LOD_L=RF_Length*(RF_NF+2*RF_NF_DG)+Ldiffgg*(RF_NF+2*RF_NF_DG+1)+2*Ldiffga (1),

AA_AREA=LOD_L*RF_Width (2),

AA_PERI=2*(LOD_L+RF_Width) (3).

As other examples of the parameters of the MOSFET model, there are an area AREA_DNWPS and a peripheral length PERI_DNWPS of the deep N-type well, and an area AREA_DNWPW and a peripheral length PERI_DNWPW of the P-type well. In the following expressions (4) to (7), those parameters are represented by the variables shown in FIG. 3.

AREA_{—}DNWPS=(LOD_L+2*(LDY_{—}PW+LDY_{—}DNW))*(RF_Width+2*(LDX_{—}PW+LDX_{—}DNW)) (4),

PERI_{—}DNWPS=2*((LOD_L+2*(LDY_{—}PW+LDY_{—}DNW))+(RF_Width+2*(LD X_{—}PW+LDX_{—}DNW))) (5),

AREA_{—}DNWPW=(LOD_L+2*LDY_{—}PW)*(RF_Width+2*LDX_{—}PW) (6),

PERI_{—}DNWPW=2*((LOD_L+2*LDY_{—}PW)+(RF_Width+2*LDX_{—}PW)) (7).

The MOSFET parameter calculation part 102A calculates the parameters of the MOSFET model, using the shape data and the above expressions. Note that the expressions (2) to (7) are represented using LOD_L shown in the expression (1).

Then, the parasitic device parameter calculation part 102B calculates the parameters of the parasitic device model, using the parameters of the MOSFET model. Examples of the parameters of the parasitic device model include a junction capacitance component CJ, a diode saturation current component IS, and a series parasitic resistance component RS of the parasitic device.

The parasitic device parameter calculation part 102B calculates those parameters of the parasitic device models between the P-type well and the deep N-type well and between the deep N-type well and the P-type substrate. Examples of the parasitic device model between the P-type well and the deep N-type well are the junction diode model D_{A} and its equivalent circuit model. Examples of the parasitic device model between the deep N-type well and the P-type substrate are the junction diode model D_{B} and its equivalent circuit (see FIG. 2).

In the following expressions (8) to (10), the parameters of the parasitic device model between the deep N-type well and the P-type substrate are represented by the parameters of the MOSFET model shown in the expressions (4) to (7).

CJ=CJA_{—}PSDNW*AREA_{—}DNWPS+CJP_{—}PSDNW*PERI_{—}DNWPS (8),

IS=ISA_{—}PSDNW*AREA_{—}DNWPS+ISP_{—}PSDNW*PERI_{—}DNWPS (9),

RS=RSA_{—}PSDNW*AREA_{—}DNWPS+RSP_{—}PSDNW*PERI_{—}DNWPS+RSUB (10).

In the expressions (8) to (10), CJA_PSDNW, ISA_PSDNW, RSA_PSDNW, CJP_PSDNW, ISP_PSDNW, and RSP_PSDNW are constants. Examples of the values of those constants are, respectively, 7.53×10⁻⁴, 9.56×10⁻⁷, 4.15×10⁺⁸, 4.05×10⁻¹⁰⁻¹⁰, 1.63×10⁻¹³, and 71.4. The substrate resistivity RSUB in the expression (10) is represented by the following expression (11):

RSUB=RSUBCONST*AREA_{—}DNWPW/AREA_{—}DNWPS (11).

RSUBCONST represents the value of RSUB when one value from each of RF_Length, RF_Width, and RF_NF is selected. For example, when RF_Length=0.3 μm, and RF_Width*RF_NF=500 μm, RSUBCONST=500.

In the following expressions (12) to (14), the parameters of the parasitic device model between the P-type well and the deep N-type well are represented by the parameters of the MOSFET model shown in the expressions (4) to (7).

CJ=CJA_{—}PWDNW*AREA_{—}DNWPW+CJP_{—}PWDNW*PERI_{—}DNWPW (12),

IS=ISA_{—}PWDNW*AREA_{—}DNWPW+ISP_{—}PWDNW*PERI_{—}DNWPW (13),

RS=RSA_{—}PWDNW*AREA_{—}DNWPW+RSP_{—}PWDNW*PERI_{—}DNWPW (14).

In the expressions (12) to (14), CJA_PWDNW, ISA_PWDNW, RSA_PWDNW, CJP_PWDNW, ISP_PWDNW, and RSP_PWDNW are constants. Examples of the values of those constants are, respectively, 2.21×10⁻⁴, 6.81×10⁻⁶, 4.94×10⁺⁸, 4.97×10⁻¹⁰, 4.04×10⁻¹², and 77.9.

The parasitic device parameter calculation part 102B calculates the parameters of the parasitic device models, using the parameters of the MOSFET model and the above expressions.

Then, the MOSFET model output part 103 generates and outputs the MOSFET model added with the parasitic device models, using the parameters of the parasitic device models.

In the present embodiment, the MOSFET model output part 103 generates the MOSFET model, using the values of CJ, IS, and RS of the parasitic device model between the P-type well and the deep N-type well, and the values of CJ, IS, and RS of the parasitic device model between the deep N-type well and the P-type substrate. However, the MOSFET model output part 103 may generate the MOSFET model by using some of the six values, for example, only the values of CJ and RS of those parasitic device models.

### (Difference Between N-Type MOSFET and P-Type MOSFET)

As described above, the MOSFET model output apparatus of the present embodiment generates and outputs the MOSFET model of the five-terminal model. However, the above description premises that the MOSFET is the N-type MOSFET.

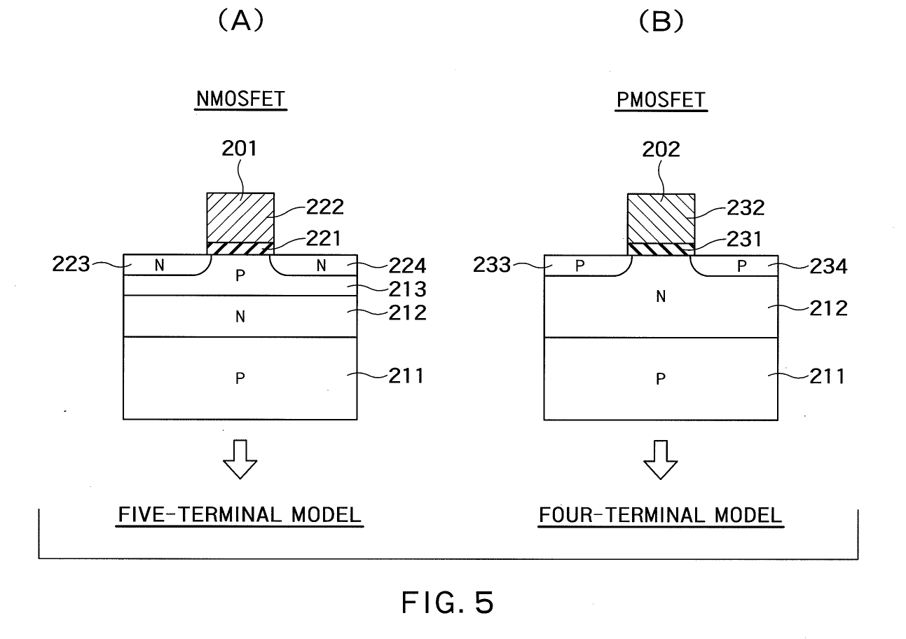

In the present embodiment, when the MOSFET is the N-type MOSFET, the MOSFET model of the five-terminal model is generated and outputted. On the other hand, when the MOSFET is the P-type MOSFET, the MOSFET model of the four-terminal model is generated and outputted. Hereinafter, details of such processing will be described with reference to FIG. 5.

FIG. 5 is a sectional side view showing cross sections of an N-type MOSFET 201 and a P-type MOSFET 202.

FIG. 5(A) shows a P-type substrate 211, a deep N-type well 212 formed on the surface of the P-type substrate 211, and a P-type well 213 formed on the surface of the deep N-type well 212. FIG. 5(A) further shows the N-type MOSFET 201 formed on the P-type well 213.

On the other hand, FIG. 5(B) shows the P-type substrate 211 and the deep N-type well 212 but does not show the P-type well 213. The P-type MOSFET 202 is formed on the deep N-type well 212.

In the present embodiment, it is assumed that the N-type MOSFET 201 is formed on the P-type substrate 211 through the deep N-type well 212 and the P-type well 213. On the other hand, it is assumed that the P-type MOSFET 202 is formed on the P-type substrate 211 only through the deep N-type well 212.

FIG. 5 further shows gate insulators 221 and 231, gate electrodes 222 and 232, source diffusion layers 223 and 233, and drain diffusion layers 224 and 234 included in the N-type MOSFET 201 and the P-type MOSFET 202, respectively.

The MOSFET models of the N-type MOSFET 201 and the P-type MOSFET 202 will be described.

In the present embodiment, when the MOSFET is the N-type MOSFET 201, the MOSFET model of the five-terminal model is generated. At that time, the structure shown in FIG. 5(A) is reflected on the MOSFET model. The examples of the five-terminal models are shown in FIGS. 2(A) to (D).

When the MOSFET is the N-type MOSFET 201, the parasitic device model between the P-type well 213 and the deep N-type well 212, and the parasitic device model between the deep N-type well 212 and the P-type substrate 211 are added to the MOSFET model. The junction diode model D_{A} and its equivalent circuit model are examples of the former parasitic device model. The junction diode model D_{B} and its equivalent circuit model are examples of the latter parasitic device model (see FIG. 2).

On the other hand, in the present embodiment, when the MOSFET is the P-type MOSFET 202, the MOSFET model of the four-terminal model is generated. At that time, the structure shown in FIG. 5(B) is reflected on the MOSFET model. As examples of the four-terminal models, there are the MOSFET models in which the respective terminals P₄ are removed from the circuit diagrams shown in FIGS. 2(A) to (D).

When the MOSFET is the P-type MOSFET 202, the parasitic device model between the deep N-type well 212 and the P-type substrate 211 is added to the MOSFET model. However, the parasitic device model between the P-type well 213 and the deep N-type well 212 is not added. For example, in terms of the example shown in FIG. 2, although the junction diode model D_{B} or its equivalent circuit model is added to the MOSFET model, the junction diode model D_{A} or its equivalent circuit model is not added.

As described above, in the present embodiment, different parasitic device models are added to the MOSFET model, in the case where the MOSFET is the N-type MOSFET 201, and in the case where the MOSFET is the P-type MOSFET 202. Consequently, the difference between the parasitic devices of the N-type MOSFET 201 and the P-type MOSFET 202 can be reflected on the MOSFET model.

In the present embodiment, the MOSFET model other than the five-terminal model may be applied to the N-type MOSFET 201, and the MOSFET model other than the four-terminal model may be applied to the P-type MOSFET 202. For example, the MOSFET model of a six-terminal model may be applied to the N-type MOSFET 201, and another MOSFET model (e.g., MOSFET model of five-terminal model) may be applied to the P-type MOSFET 202.

### Effects of Present Embodiment

The effects of the present embodiment will be described.

As described above, in the present embodiment, the parameters of the parasitic device model to be added to the MOSFET model are calculated using the shape data of the MOSFET. Then, the MOSFET model added with the parasitic device model is generated and outputted using the parameters of the parasitic device model.

Further, in the present embodiment, different parasitic device models are added to the MOSFET model, in the case where the MOSFET is the N-type MOSFET 201, and in the case where the MOSFET is the P-type MOSFET 202.

According to the above configuration, in the present embodiment, the difference between the parasitic devices of the N-type MOSFET 201 and the P-type MOSFET 202 can be reflected on the MOSFET model. Consequently, it is possible to generate a high-accuracy MOSFET model suitably incorporating the effects of the parasitic devices.

In the present embodiment, for example, when the MOSFET is the N-type MOSFET 201, the MOSFET model of the five-terminal model is used. In this case, the parasitic device model between the P-type well 213 and the deep N-type well 212 and the parasitic device model between the deep N-type well 212 and the P-type substrate 211 are added to the MOSFET model.

On the other hand, when the MOSFET is the P-type MOSFET 202, the MOSFET model of the four-terminal model is used. In this case, the parasitic device model between the deep N-type well 212 and the P-type substrate 211 is added to the MOSFET model. However, the parasitic device model between the P-type well 213 and the deep N-type well 212 is not added.

Consequently, in the present embodiment, the structures shown in FIGS. 5(A) and 5(B) can be reflected on the MOSFET model.

There will be described the effects obtained when the five-terminal model is applied to the N-type MOSFET 201, and the parasitic device model is added to the five-terminal model.

As the first effect, the bias dependence of the deep N-type well 212 can be considered, whereby the accuracy of the simulation using the MOSFET model can be enhanced.

As the second effect, the substrate and the well are connected on the net list, whereby the cross-talk noise analysis important in mixed-signal circuit designing can be performed. According to the present embodiment, analysis of the parasitic effect of the substrate, and a verification of digital noise wrapped around through the substrate are enabled.

As the third effect, in the connection verifications after the layout designing, the connection verification of the deep N-type well 212 can be performed.

In the present embodiment, the parameters of the parasitic device model are calculated, using the functions including the variables shown in FIG. 4, such as the expressions (1) to (14). Consequently, in the present embodiment, the scalable and highly versatile MOSFET model can be designed. In the present embodiment, the parameters of the MOSFET model can be calculated from the shape data of the MOSFET by the expressions (4) to (7). Further, the parameters of the parasitic device model can be calculated from the parameters of the MOSFET model by the expressions (8) to (14). The parameters (CJ, IS, and RS) of the parasitic device model are the SPICE model parameters of the junction diode.

In the present embodiment, the net list of the MOSFET model added with the parasitic device model is generated and outputted. The net list can be used in the SPICE circuit simulation performed inside or outside the apparatus of FIG. 1.

The processing performed by the apparatus of FIG. 1 may be realized by a circuit executing this processing, for example. Alternatively, the processing may be realized by a computer program for causing a computer to execute the processing. The computer program is recorded in a computer readable recording medium such as a CD-ROM, a DVD, a semiconductor memory, and a magnetic recording memory, and the computer program is used by the computer. A computer including the above circuit, and a computer installed with the above computer program are examples of the information processing apparatus of the disclosure.

Although the MOSFET model outputted from the apparatus of FIG. 1 is applicable to, for example, the simulation of various analog circuits and the simulation of various RF circuits, the MOSFET model may be applied to the simulation of other circuits. The MOSFET model of the present embodiment is applicable to the simulation of an RF-CMOS circuit, for example.

As described above, embodiments described herein can provide a MOSFET model output apparatus and method, and a recording medium which can generate a high-accuracy MOSFET model suitably incorporating the effects of the parasitic device.

While certain embodiments have been described, these embodiments have been presented by way of example only, and are not intended to limit the scope of the inventions. Indeed, the novel apparatuses, methods and media described herein may be embodied in a variety of other forms; furthermore, various omissions, substitutions and changes in the form of the apparatuses, methods and media described herein may be made without departing from the spirit of the inventions. The accompanying claims and their equivalents are intended to cover such forms or modifications as would fall within the scope and spirit of the inventions.

1. An apparatus for outputting a MOSFET model for a simulation of a semiconductor circuit, the apparatus comprising:
an input processor configured to input shape data relating to a MOSFET;
a calculator configured to calculate, using the shape data, one or more parasitic device model parameters; and
an output processor configured to generate and output the MOSFET model added with at least one parasitic device models, using the one or more parasitic device model parameters,
wherein the added parasitic device model(s) depend on whether the MOSFET is an N-type MOSFET or a P-type MOSFET.

2. The apparatus of claim 1, wherein
in the case in which the MOSFET is an N-type MOSFET, the output processor is configured to add to the MOSFET model a parasitic device model between a P-type substrate and a deep N-type well, and a parasitic device model between the deep N-type well and a P-type well to the MOSFET model, and
in the case in which the MOSFET is a P-type MOSFET, the output processor is configured to add to the MOSFET model a parasitic device model between the P-type substrate and the deep N-type well.

3. The apparatus of claim 1, wherein
in the case in which the MOSFET is an N-type MOSFET, the output processor is configured to generate and output a MOSFET model comprising a five-terminal model, and
in the case in which the MOSFET is a P-type MOSFET, the output processor is configured to generate and output a MOSFET model comprising a four-terminal model.

4. The apparatus of claim 1, wherein at least one parasitic device model comprises a junction diode.

5. The apparatus of claim 1, wherein at least one parasitic device model comprises an equivalent circuit of a junction diode.

6. The apparatus of claim 5, wherein the equivalent circuit comprises a series connection of a resistor and a capacitor.

7. The apparatus of claim 5, wherein the equivalent circuit comprises a series connection of a resistor, an inductor, and a capacitor.

8. The apparatus of claim 1, wherein the calculator comprises:
a MOSFET parameter calculator configured to calculate, using the shape data, one or more parameters of the MOSFET model; and
a parasitic device parameter calculator configured to calculate, using the one or more parameters of the MOSFET model, the one or more parasitic device model parameters.

9. The apparatus of claim 1, wherein the calculator is configured to calculate the one or more parasitic device model parameters using shape data comprising one or more of
a gate length of the MOSFET,
a gate width of the MOSFET,
a gate finger number of the MOSFET,
a dummy gate finger number of the MOSFET,
a distance between gates of the MOSFET,
a distance between an dummy gate edge and an active area edge of the MOSFET,
a distance in a first direction between the active area edge and a boundary between a P-type well and a deep N-type well,
a distance in a second direction between the active area edge and the boundary between the P-type well and the deep N-type well,
a distance in the first direction between the boundary between the P-type well and the deep N-type well and a boundary between the deep N-type well and a P-type substrate, and
a distance in the second direction between the boundary between the P-type well and the deep N-type well and the boundary between the deep N-type well and the P-type substrate.

10. The apparatus of claim 8, wherein
the MOSFET parameter calculator is configured to calculate, as the one or more parameters of the MOSFET model, a length of an active area, an area of the active area, a peripheral length of the active area, an area of a deep N-type well, a peripheral length of the deep N-type well, an area of a P-type well, and/or a peripheral length of the P-type well.

11. The apparatus of claim 8, wherein
the parasitic device parameter calculator is configured to calculate, as the one or more parameters of the parasitic device model, a junction capacitance component, a diode saturation current component, and/or a series parasitic resistance component of a parasitic device.

12. The apparatus of claim 1, wherein
the output processor is configured to generate a list of information regarding the MOSFET model(s) and the parasitic device model(s), and output the list.

13. A method of outputting a MOSFET model for a simulation of a semiconductor circuit, the method comprising:
with a computer comprising at least one processor,
inputting shape data regarding a MOSFET;
using the shape data, calculating one or more parasitic device model parameters to be added to the MOSFET model; and
generating and outputting the MOSFET model added with at least one parasitic device models using the one or more parasitic device model parameters,
wherein the added parasitic device model(s) depend on whether the MOSFET is an N-type MOSFET or a P-type MOSFET.

14. The method of claim 13, comprising
in the case in which the MOSFET is an N-type MOSFET, adding to the MOSFET model a parasitic device model between a P-type substrate and a deep N-type well, and a parasitic device model between the deep N-type well and a P-type well, and
in the case in which the MOSFET is a P-type MOSFET, adding to the MOSFET model a parasitic device model between the P-type substrate and the deep N-type well.

15. The method of claim 13, comprising
in the case in which the MOSFET is an N-type MOSFET, generating and outputting a MOSFET model comprising a five-terminal model, and
in the case in which the MOSFET is a P-type MOSFET, generating and outputting a MOSFET model comprising a four-terminal model.

16. The method of claim 13, wherein calculating the one or more parasitic device model parameters comprises
calculating one or more parameters of the MOSFET model, using the shape data; and
calculating the one or more parasitic device model parameters, using the parameter of the MOSFET model.

17. The method of claim 16, wherein
calculating one or more parameters of the MOSFET model comprises calculating a length of an active area, an area of the active area, a peripheral length of the active area, an area of a deep N-type well, a peripheral length of the deep N-type well, an area of a P-type well, and/or a peripheral length of the P-type well.

18. The method of claim 16, wherein
the calculating the one or more parasitic device model parameters comprises calculating a junction capacitance component, a diode saturation current component, and/or a series parasitic resistance component of a parasitic device.

19. The method of claim 13, wherein
generating and outputting the MOSFET model added with the at least one parasitic device models comprises generating a list of information regarding the MOSFET model(s) added with the parasitic device model(s), and outputting the list.

20. A computer readable recording medium storing a program to cause a computer to execute a method of outputting a MOSFET model for a simulation of a semiconductor circuit, the method comprising:
calculating one or more parasitic device model parameters using shape data of a MOSFET inputted into the computer; and
generating and outputting the MOSFET model added with at least one parasitic device models, using the one or more parasitic device model parameters,
wherein the added parasitic device model(s) depend on whether the MOSFET is an N-type MOSFET or a P-type MOSFET.
